(19) United States
(12) Patent Application Publication
(10) Pub. No.: US 2022/0236053 A1
(43) Pub. Date: Jul. 28, 2022

(54) HYDRAULICALLY PROPELLED INSPECTION PLATFORM

(71) Applicant: Chevron U.S.A. Inc., San Ramon, CA (US)

(72) Inventor: Pablo Mauricio CALVA VALDERRABANO, Houston, TX (US)

(21) Appl. No.: 17/158,835

(22) Filed: Jan. 26, 2021

(51) Int. Cl. G01B 17/02; B60K 8/00

(52) U.S. Cl. CPC G01B 17/02; B60K 8/00

(57) ABSTRACT

A hydraulically propelled inspection platform for an oil and gas facility includes a frame, at least one wheel secured to the frame, and at least one hydraulically-driven engine secured to the frame and configured to motivate the platform in one or more directions defined by the wheel. The platform also includes at least one inspection sensor secured to the frame and configured to allow inspection of the oil and gas facility.

### FIELD OF THE INVENTION

The present invention relates generally to a hydraulically propelled inspection platform. More specifically, the present invention relates to a hydraulically propelled inspection platform mounted with water engines.

### BACKGROUND

Remote inspection of platforms where gas or vapors are normally present can be challenging. Remote inspection may involve the use of a motorized, mobile platform with sensors. The motor of devices that are used for such inspection tend to be electrical, which may not be compatible with the gas-rich environment to be inspected.

Therefore, a need exists for a mobile platform that uses non-electric motor propulsion. It is now recognized that using water turbines can provide a non-electrical manner of locomotion for spark-sensitive environments.

### SUMMARY OF THE INVENTION

The following described technology is made in an effort to provide a hydraulically propelled inspection platform mounted with water engines.

To achieve the above aim, the hydraulically propelled inspection platform may include a frame and platform; at least a wheel; and at least a water engine.

Pressurized water engines (water turbines) connected to the wheels are mounted on the frame and platform. Hoses (water supply pipe) tied as an umbilical cord deliver the pressurized water to the water turbines. Control valves controlling the water flow allow to control forward direction when both the two water turbines are driven and steering capabilities by increasing or limiting the flow to one or the other water turbine. The frame and platform are designed to carry cameras and other inspection tools like ultrasonic-thickness probes.

### Advantageous Effects of Invention

According to certain embodiments of the present invention, a hydraulically propelled inspection platform is mounted with water engines. The advantage of the present invention using the hydraulically propelled inspection platform may inspect floating roof and floors of storage tanks, floating roof tank pontoons, hydrocarbon, process and storage vessels interior, piping process intern al inspection, inspection of process areas with gas or vapors present.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings, in which like reference symbols indicate the same or similar components, wherein:

FIG. 1 is a prototype of a hydraulically propelled inspection platform in accordance with an example embodiment of the present invention.

FIG. 2 is a side view of the prototype of the hydraulically propelled inspection platform of FIG. 1.

FIG. 3 is a top view of a prototype of a hydraulically propelled inspection platform in accordance with another exemplary embodiment of the present invention.

FIG. 4 is a side view of the prototype of the hydraulically propelled inspection platform of FIG. 3.

FIG. 5(A) is a three dimensional image of a hydraulically propelled inspection platform in accordance with another exemplary embodiment of the present invention.

FIG. 5(B) is a perspective view of the hydraulically propelled inspection platform of FIG. 5(A).

FIG. 6 is a side view of the hydraulically propelled inspection platform of FIG. 5(B).

FIG. 7 is a top view of the hydraulically propelled inspection platform of FIG. 5(B).

FIG. 8 is a front view of the hydraulically propelled inspection platform of FIG. 5(B).

FIG. 9 is a schematic diagram of a hydraulically propelled inspection platform in accordance with another exemplary embodiment of the present invention.

FIG. 10 is a side view of the hydraulically propelled inspection platform of FIG. 9.

### DETAILED DESCRIPTION OF THE INVENTION

The general inventive concept is described more fully below with reference to the accompanying drawings, in which exemplary embodiments of the present invention are shown. As those skilled in the art would realize, the described embodiments may be modified in various different ways, all without departing from the spirit or scope of the present invention. The present invention should not be construed as being limited to the embodiments. Accordingly, the drawings and description are to be regarded as illustrative in nature to explain aspects of the present invention and not restrictive. Like reference numerals in the drawings designate like elements throughout the specification, and thus their description have not been repeated.

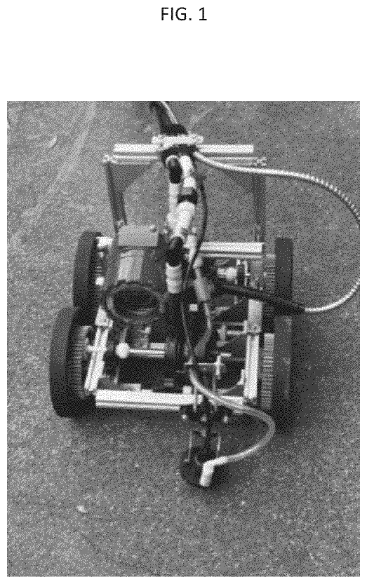

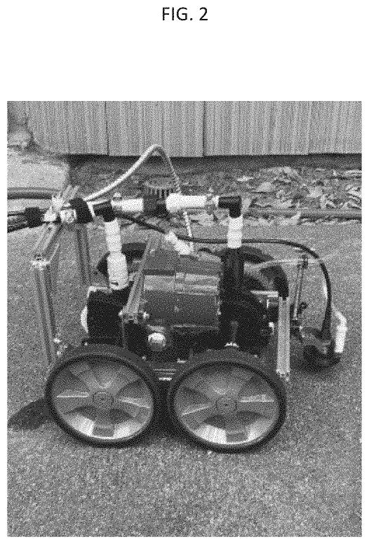

FIG. 1 is a prototype of a hydraulically propelled inspection platform equipped with inspection sensors, e.g., a camera and ultrasonic probe in accordance with an exemplary embodiment of the present invention. FIG. 2 is a side view of the prototype of the hydraulically propelled inspection platform of FIG. 1.

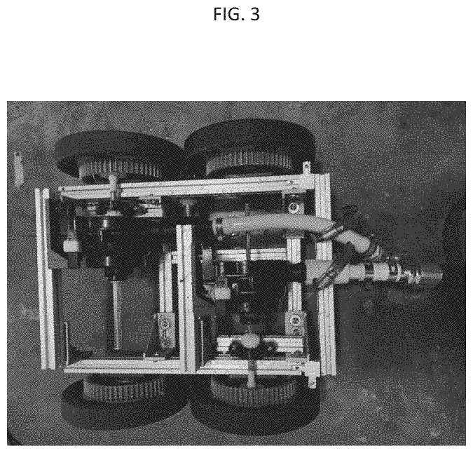

FIG. 3 is a top view of a prototype of a hydraulically propelled inspection platform in accordance with another exemplary embodiment of the present invention.

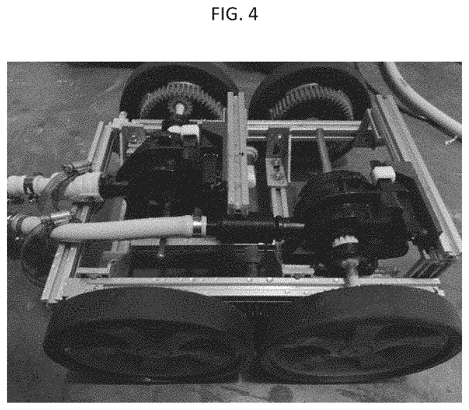

FIG. 4 is a side view of the prototype of the hydraulically propelled inspection platform of FIG. 3.

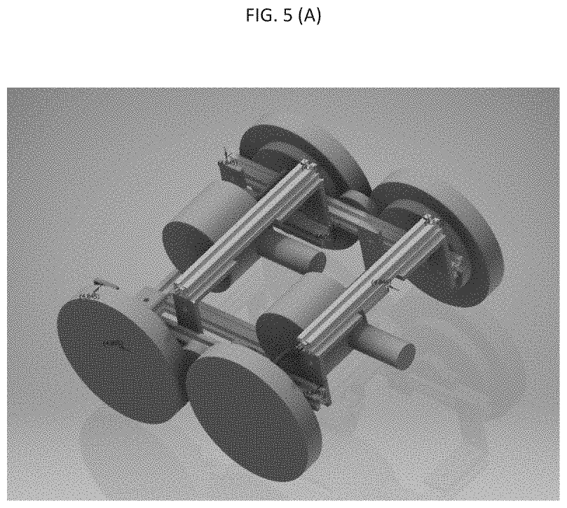

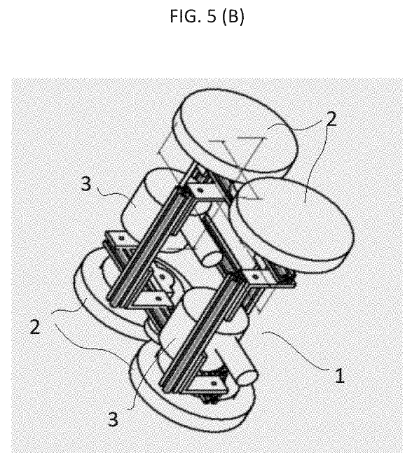

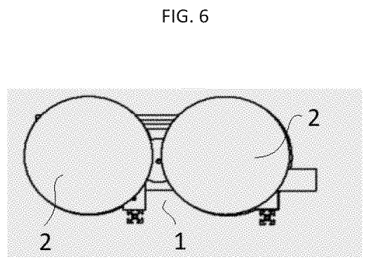

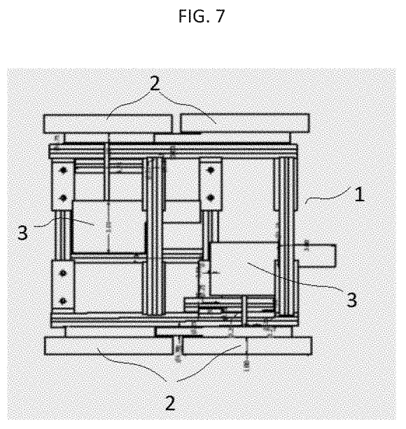

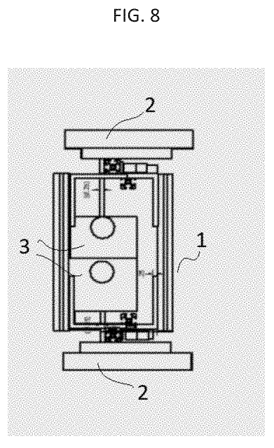

FIG. 5(A) is a three dimensional image of a hydraulically propelled inspection platform in accordance with another exemplary embodiment of the present invention. FIG. 5(B) is a perspective view of the hydraulically propelled inspection platform of FIG. 5(A). FIG. 6 is a side view of the hydraulically propelled inspection platform of FIG. 5(B). FIG. 7 is a top view of the hydraulically propelled inspection platform of FIG. 5(B). FIG. 8 is a front view of the hydraulically propelled inspection platform of FIG. 5(B).

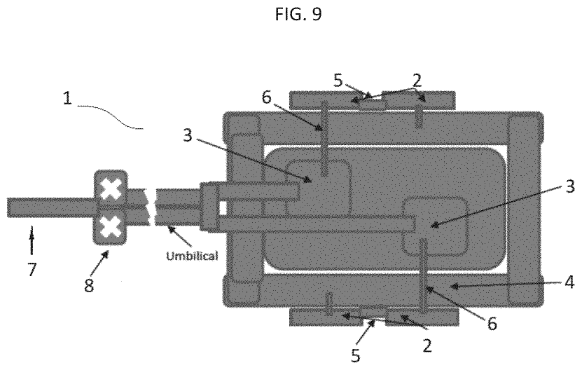

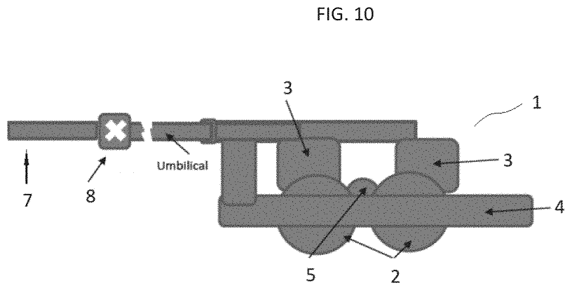

FIG. 9 is a schematic diagram of a hydraulically propelled inspection platform in accordance with another exemplary embodiment of the present invention. FIG. 10 is a side view of the hydraulically propelled inspection platform of FIG. 9.

Referring to the drawings of FIGS. 5-10, the depicted hydraulically propelled inspection platform 1 may include one or more wheels 2 and one or more engines 3 (e.g., four wheels and two engines). The two water engines 3 may be designed in a similar manner to water engines used in a pressure-side pool cleaning device. The engines 3 may be mounted on a frame, for example a 80/20 aluminum extruded profile frame. One of the engines 3 may be drivingly connected to the left wheels 2, and another engine 3 may be drivingly connected to the right wheels 2, giving a steering capability obtained by turning water pressure on or off from one side or the other. In another variation, one engine 3 may be connected to the front wheels 2 and the other engine 3 may be connected to the back wheels 2 to have forward-backward direction. In more complex configurations, four engines (not shown) may be used to have steering and forward-backward control.

The prototype assembled may be used to demonstrate the concept of using water-pressure engines to propel a platform. The final configuration, parts and materials used may change to adopt to specific uses.

Referring to the drawings of FIGS. 9-10, a hydraulically propelled inspection platform 1 may include a frame and platform 4, four wheels 2 and two water turbines 3. Two wheels 2 may be located on one side of the frame and platform 4, while other two wheels 2 may be located on another side of the frame and platform 4. The two water turbines 3 may be located on top of the frame and platform 4. Two gears 5 may be located on the frame and platform 4 between the wheels 2. Two axles 6 may be located to connect the wheels 2 and the water turbines 3. Water supply pipe 8 may be connected to the two water turbines 3. Control valves 7 may be located on the water supply pipe 8 to control the water flow allow and to control forward direction when both the two water turbines 3 are driven and steering capabilities by increasing or limiting the flow to one or the other water turbine 3.

The hydraulically propelled inspection platform as described herein may be useful for, among other things, inspection of devices, equipment, and so forth, in any environment that may be sensitive to live electrical equipment. By way of example, such environments may include facilities that employ vessels, pipes, and the like, that may house and/or emit vapors and/or gases. By way of more specific example, such environments may include oil and gas production facilities, refineries, offshore platforms, and the like.

The foregoing description details certain preferred embodiments of the present invention and describes the best mode contemplated. It will be appreciated, however, that changes may be made in the details of construction and the configuration of components without departing from the spirit and scope of the disclosure. Therefore, the description provided herein is to be considered exemplary, rather than limiting, and the true scope of the invention is that defined by the following claims and the full range of equivalency to which each element thereof is entitled.

What is claimed is:

1. A hydraulically propelled inspection platform for an oil and gas facility comprising:
a frame;
at least one wheel secured to the frame;
at least one hydraulically-driven engine secured to the frame and configured to motivate the platform in one or more directions defined by the wheel; and
at least one inspection sensor secured to the frame and configured to allow inspection of the oil and gas facility.
